(19) United States
(12) Patent Application Publication
(10) Pub. No.: US 2012/0255226 A1
(43) Pub. Date: Oct. 11, 2012

(54) Plant Water Catch Basin

(76) Inventor: Yolanda Salen, Colonia, NJ (US)

(21) Appl. No.: 13/242,390

(22) Filed: Sep. 23, 2011

Related U.S. Application Data
(60) Provisional application No. 61/385,593, filed on Sep. 23, 2010.

(51) Int. Cl. A01G 9/04

(52) U.S. Cl. 47/71

(57) ABSTRACT

A water catching basin for placement under plant holders that is designed to capture and hold water that may drain from a plant holder or spill over the edge of the plant holder during the watering process of the contained plant. The exterior of the water catching basin is decorative so when a user needs to bring an outdoor plant indoors, the plant can sit in an attractive water catching basin. The basin also protects furniture and flooring from water spillage that may occur. The device features a draining hole locatable at the center of its base for the purpose of draining water that has collected in the device. A drain plug prevents water from escaping the device until the user is ready to empty the device. A water absorbent material, such as sponge, can fill the interior base of the device to allow for better water collection and retention.

### CROSS REFERENCE TO RELATED APPLICATION

This application claims the benefit of U.S. Provisional Application No. 61/385,593 filed on Sep. 23, 2010, entitled “Pottums.”

### BACKGROUND OF THE INVENTION

1. Field of the Invention

The present invention relates to water catching basins for use in conjunction with plant holders. More specifically, the present invention provides both an aesthetically pleasing exterior to an ordinary plant holder while protecting furniture, carpet or floors from water damage by catching any spillage that may occur during the watering process of those plants that require being moved indoors due to inclement weather or sharp temperature changes outdoors.

2. Description of the Prior Art

Gardening is a very popular hobby that many individuals derive pleasure from. Some individuals enjoy growing plants outdoors. These gardeners cultivate plants in configurations such as vegetable patches, rose gardens or herb gardens. However, when there is a lack of available ground for the gardener to plant in, or the particular plant requires specific care, a gardener may choose to grow the plant in an individual pot. Occasionally, cold temperatures or inclement weather may necessitate moving a potted plant from the outdoors to indoors in order to provide the plant with protection. Outdoor plant holders, however, are often times not designed with the aesthetics of interior decorating in mind—they are typically plain and neutral in color—and it is very unlikely that the plant holder will match the décor of the indoor room the plant is stored in.

Another concern when moving plants indoors is water damage to furniture, floors and carpets. Plants require maintenance and watering to remain healthy and green. Under-watering can result in weak, dehydrated and unhealthy plants. Over-watering, on the other hand, can lead to soil saturation and overflow, or spillage, of the water over the edges of the plant holder, resulting in a mess and potential damage to the surface of the furniture upon which the plant holder sets.

Some similar patented devices exist and include potted plant saucers used to support a pot to collect water. Several patents have been granted to devices that attempt to provided a means of collecting excess water that accumulates after watering a plant, yet these prior art devices have several known drawbacks.

U.S. Pat. No. 7,093,391 to Eakin describes a plant holder and a drainage tray combination. The plant holder has a drainage hole at the bottom of the planter that allows water to flow out of the planter and into the drainage tray. The drainage tray is wider in circumference than the base of the plant holder and from the side of the drainage tray, there is an attached drainage tube for the purpose of deterring the collection of water in the draining tray. Water that percolates through the plant's soil and drains through the plant holder's drainage hole will collect in the draining tray and flow out the draining tube. The draining tube is made from a flexible material. The purpose of the draining tube is to direct water away from the plant holder. A user could direct the draining tube toward other plants or flowers so that the drained water is not wasted and is used, instead, to water other plants.

The Eakin device does not provide a means of keeping any drained water in the draining tray—rather water exits the draining tray through the draining tube. Using the Eakin device when plants have been brought indoors will likely cause damage to furniture and floors if the device is allowed to drain through its draining tube. Even if the draining tube of the Eakin device is set up to drain into another planter, there is the risk that the tube may come loose and drip water onto furniture or flooring. The present invention will not leak water that has collected in its water catching tray. Since the present invention is not physically attached to the plant holder, a user can remove the plant if so desired when it is time to drain the device. The present invention has a hole at the bottom of the water catching tray that has a drainage plug in it. When water has collected in the tray, a user will move the device to a sink or outdoors, remove the drainage plug and drain the collected water out of the device.

U.S. Pat. No. 4,092,804 to Morris describes a plant holder and interlocking saucer device for discouraging water from accumulating in the soil contained in a plant holder. The plant holder has draining holes at its bottom, similar to the Eakin device. The interlocking saucer is designed to be detachable by snapping onto, and off of, the bottom of the plant holder. The saucer does not attach flushly with the bottom of the saucer. Rather, the planter is suspended above the saucer by a set of small offsets, which provide a space between the bottom of the plant holder and the saucer for adequate irrigation and drainage.

The Morris device does not offer a means for removing water that accumulates in the draining tray. When the Morris device is used indoors, a user would have to detach the saucer to drain it, which requires unsnapping the saucer. The jostling that occurs while unsnapping the saucer could disrupt the water in the saucer and cause it to spill out onto furniture, the floor and onto the user. The user could carry the device to a sink and unsnap the saucer, but the same problem with water spilling during detachment of the saucer is still likely to occur. The present invention employs the use of an absorbent material, such as a sponge, to absorb part of the water that accumulates in the basin of the device. Additionally, because the plant holder sits in the present invention, rather than physically attaches to the plant holder, a user could simply remove the plant without jostling the collected water to the point of accidental spillage. When a plant holder is set inside the device, drainage of the present invention can be facilitated by removing the stopper on the bottom of the water catching basin, or, if the plant holder is removed from the device, a user could tilt the water collecting basin on its side and pour the water out of the device without risking spillage onto furniture or the floor.

U.S. Pat. No. 3,981,099 to Dziewulski III describes a hanging plant holder with a detachable water catching tray affixed to the bottom of the plant holder device. The tray is designed to catch spillage that may occur during the process of watering the plant contained in the hanging plant holder. The tray is larger in circumference than the base of the hanging plant holder and has a retaining wall, which forms an edge to keep water in the tray once it collects there, serving as a water reservoir. The patent describes the planter as having a hanging means, connected to a plant holder. The plant holder is cylindrical pot, having a top opening a bottom and a side wall. The top opening of the plant holder has a wider top diameter than the base of the plant. Attached to the exterior of the plant holder base is the water catching tray. The tray and plant holder are attached by aligning a set of latches located on the tray with a set of holes in the bottom of the plant holder and twisting the two in opposite directions until the plant holder and the tray lock together.

The device described in the Dziewulski III patent employs the use of a very shallow water catching tray. The edges of the tray only allow for a limited amount of water to be collected. If a user does not diligently remove water that collects in the tray, the tray will overflow, or it is likely that a user will spill the collected water when attempting to remove a full tray from the device. The present invention is not physically attached to the plant holder, and employs high, upstanding edges on the water collecting basin that allow the present invention to contain more water than the Dziewulski III device. One embodiment of the present invention features the use of a spongy, water-absorbent material to absorb even more water that collects in the water catching basin and further prevent spillage.

The present invention substantially diverges in design elements from the prior art and consequently it is clear that there is a need in the art for an improvement to existing water catching devices for plant holders. In this regard the instant invention substantially fulfills these needs.

### SUMMARY OF THE INVENTION

In view of the foregoing disadvantages inherent in the known types of plant holders with water catching trays or saucers attached to them now present in the prior art, the present invention provides a new water catching basin for potted plants wherein the same can be utilized for providing convenience for the user when the time comes to remove the collected water from the water catching basin.

It is therefore an object of the present invention to provide a new and improved water catching basin device for potted plants that has all of the advantages of the prior art and none of the disadvantages.

Another object of the present invention to provide a means of catching and containing water spillage that may occur during the process of watering a plant.

Another object of the present invention is to provide a user with a means of emptying the water from the water catching basin that reduces the chances of a user getting wet during the draining process and protects furniture and floors from sustaining water damage in the event that plants are kept indoors.

Yet another object of the present invention is to provide means of making an outdoor pot holder more attractive when placed in indoor environments.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 is a perspective view of the present invention, and its connection and arrangement with respect to a potted plant.

FIG. 2 is a perspective view of the present invention, highlighting the drainage hole and drainage hole plug of the device.

FIG. 3 is a perspective view of the present invention that illustrates incorporation of an absorbent pad within the water catching basin to retain water within the pad, increase the volume of water that the device can hold and further prevent spillage.

### DETAILED DESCRIPTION OF THE INVENTION

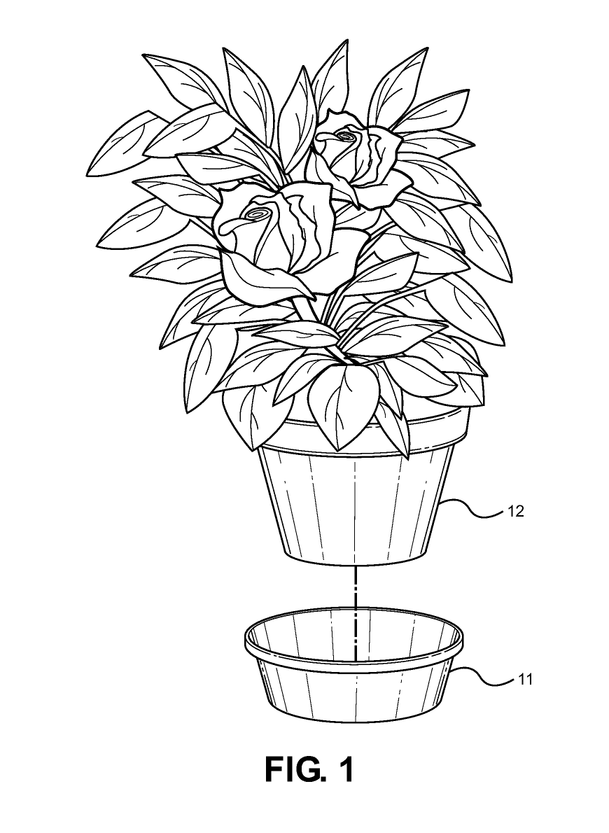

Referring now to FIG. 1, there is shown a perspective view of the present invention, wherein a plant growing in a plant holder 12 is placed in the water catching basin 11 of the present invention. The water catching basin 11 comprises a largely cylindrical shape, having a closed bottom and an open top and a side wall. The water catching basin exterior side wall can be manufactured in a variety of sizes, shapes, colors and designs such that a user may choose a water catching basin device that suits the aesthetic needs of a user. The bottom of the water catching basin 11 may have circumference that is smaller than the circumference of the open top, providing a saucer configuration and expands its cross-sectional area moving from its closed bottom to its open top. The bottom of the device has a drainage hole in the center for draining the device. One embodiment of the present invention incorporates additional weight into the base of the water catching device—creating an anchoring effect—giving the overall plant holder and water catching basin device enhanced stability. The water catching basin can be made from many different materials, including but not limited to, ceramic material, glass or plastic.

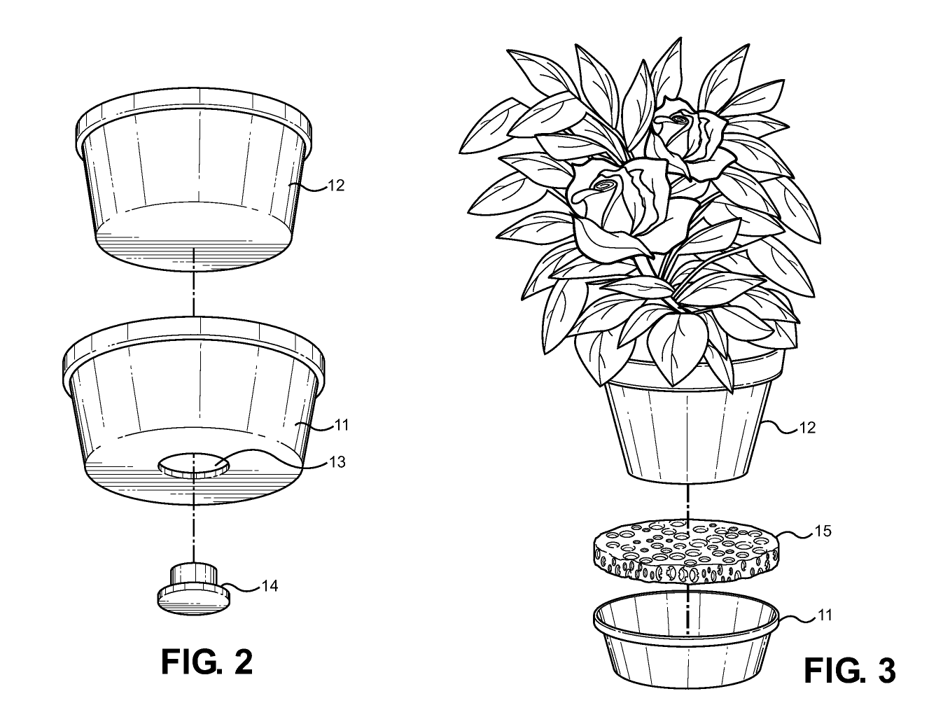

Referring now to FIG. 2, there is shown a perspective underside view of the present invention, highlighting the centrally located draining hole 13 along the bottom of the water catching basin 11, and illustrating the drainage hole plug 14. The drainage hole plug can be made from a material such as rubber. The water catching basin 11 features a drainage hole 13 that allows a user to empty the device without having to remove the plant that rests inside the device. A user would remove the drainage hole plug 14 to release the collected water from the water catching basin 11. When finished emptying the collected water, the user can reinsert the drainage hole plug 14 into the drainage hole 13 of the device.

Referring now to FIG. 3, there is shown a perspective view of the present invention illustrating insertion of an optional absorbent pad 15 into the water catching basin 11. This embodiment of the present invention allows a user to place an absorbent pad 15 along the bottom interior of the water catching basin 11, wherein the plant holder 12 will be positioned during use. The absorbent pad reduces freely flowing water within the catching basin 11, increases the volume of water within catching basin prior to draining and reduces the probability of overflow or spillage. The absorbent pad can be made out of many water absorbent materials, including, but not limited to, a sponge, a swatch of cotton or a scrap of wool.

Whether a potted plant is stored outdoors or indoors, the present invention can be utilized to prevent spillage and overflow of water, while providing an aesthetic supplement for a potted plant. To use the device, a user first chooses a water catching basin with the desired aesthetic qualities to meet the user's preferences. Next, the user ensures the drain plug has been inserted into the draining hole along the base of the water catching basin to protect against leakage when the device is in use. A user then has the option to place an absorbent pad along the interior bottom of the water catching basin. A plant holder may then be set on top of the absorbent pad within the water catching basin. The present invention is designed to work with existing potted plant holders, including those having drainage holes located at their base and those that are comprised of a continuous construction. Those with drainage holes allow water to drain out of the soil of the plant and into the surrounding soil or surface placed thereon. The present invention is designed to catch any water that drains from a potted plant and to catch water that spills over the edges of the plant holder during the watering process. The device further acts as a support device for the plant that prevents tipping, as the catching basin may be provided using a dense material that provides a weighted base for a plant holder.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A water catching basin for use as a base under a plant holder for the purpose of catching water that either drains from the potted plant through drainage holes along the base of said plant holder or spillage that occurs during a watering process, comprising:
a water catching basin having a base, an open top and an upstanding sidewall,
said water catching basin further comprising an interior volume and an exterior sidewall surface;
said water catching basin having a drainage hole along said base for water drainage;
a drainage hole plug for plugging said drainage hole;
an optional absorbent pad adapted to fit along said base within said basin interior volume.

2. The device of claim 1, further comprising said basin sidewall having a cylindrical shape.

3. The device of claim 2, further comprising said cylindrical sidewall having base with a smaller circular circumference than said open top circumference.

3. The device of claim 1, wherein said exterior side wall of said water catching basin is decorative.

4. The device of claim 1, wherein said absorbent pad is a sponge material.

5. The device of claim 1, wherein said absorbent pad completely covers said interior bottom of said water catching basin.

6. The device of claim 1, wherein said water catching device is weighted at said bottom for enhancing overall stability of said device.

7. The device of claim 1, wherein said water catching basin is made of a ceramic material.

8. The device of claim 1, wherein said drainage hole plug is made of rubber.
